(19) United States
(12) Patent Application Publication
(10) Pub. No.: US 2013/0106850 A1
(43) Pub. Date: May 2, 2013

(54) REPRESENTATIVE IMAGE DECISION APPARATUS, IMAGE COMPRESSION APPARATUS, AND METHODS AND PROGRAMS FOR CONTROLLING OPERATION OF SAME

(71) Applicant: FUJIFILM Corporation, Tokyo (JP)

(72) Inventor: Hisashi ENDO, Ashigarakami-gun (JP)

(73) Assignee: FUJIFILM Corporation, Tokyo (JP)

(21) Appl. No.: 13/726,389

(22) Filed: Dec. 24, 2012

Related U.S. Application Data
(63) Continuation-in-part of application No. PCT/JP2011/060687, filed on Apr. 27, 2011.

(30) Foreign Application Priority Data
Jun. 29, 2010 (JP) 2010-147755

(51) Int. Cl. G06T 15/40

(52) U.S. Cl. CPC G06T 15/40
USPC 345/421

(57) ABSTRACT

A representative image of a plurality of images captured from different viewpoints is decided. An occlusion region that does not appear in a right-eye image is detected in a left-eye image. Similarly, an occlusion region that does not appear in a left-eye image is detected in a right-eye image. Scores are calculated from the characteristics of the images of the occlusion regions. The image containing the occlusion region having the higher score calculated is adopted as the representative image.

### TECHNICAL FIELD

This invention relates to a representative image decision apparatus, an image compression apparatus and methods and programs for controlling the operation thereof.

### BACKGROUND ART

It has become possible to image solids and display them as stereoscopic images. In the case of a display device that cannot display stereoscopic images, selecting a representative image from a plurality of images representing a stereoscopic image and displaying the selected representative image has been given consideration. To achieve this, there is for example a technique (Japanese Patent Application Laid-Open No. 2009-42900) for selecting an image that has grasped the features of a three-dimensional object from a moving image obtained by imaging the three-dimensional object. However, there are cases where an important subject does not appear in the selected image although it does appear in the other images. Furthermore, there is a technique (Japanese Patent Application Laid-Open No. 6-203143) for extracting an occlusion region (a hidden region), which indicates a portion of an image that does not appear in other images, from among images of a plurality of frames obtained by imaging from a plurality of different viewpoints, and finding the outline of a subject with a high degree of accuracy. However, a representative image cannot be decided upon. Further, when compression is applied to a plurality of images at a uniform ratio, there are instances where the image quality of important images declines.

### DISCLOSURE OF THE INVENTION

An object of the present invention is to decide a representative image in which an important subject portion will also appear. A further object of the present invention is to not cause a decline in the image quality of an important image.

A representative image decision apparatus according to a first aspect of the present invention is characterized by comprising: an occlusion region detection device (occlusion region detection means) for detecting, from each image of a plurality of images captured from different viewpoints and having at least one portion in common, an occlusion region that does not appear in the other images; a score calculation device (score calculation means) for calculating scores, which represent degrees of importance of the occlusion regions detected by the occlusion region detection device, based upon ratios of a prescribed object contained in the occlusion regions of each of the plurality of images; and a decision device (decision means) for deciding that an image containing an occlusion region for which the score calculated by the score calculation device is high is a representative image.

The first aspect of the present invention also provides an operation control method suited to the above-described representative image decision apparatus. Specifically, the method comprises: an occlusion region detection device detecting, from each of a plurality of images captured from different viewpoints and having at least one portion in common, an occlusion region that does not appear in the other images; a score calculation device calculating scores, which represent degrees of importance of the occlusion regions detected by the occlusion region detection device, based upon ratios of a prescribed object contained in the occlusion regions of each of the plurality of images; and a decision device deciding that an image containing an occlusion region for which the score calculated by the score calculation device is high is a representative image.

The first aspect of the present invention also provides a program for implementing the method of controlling the operation of the above-described representative image decision apparatus. It may be arranged so that a recording medium on which such an operation program has been stored is provided.

In accordance with the present invention, an occlusion region is detected from each image of a plurality of images, the detected occlusion region not appearing in the other images. Scores representing degrees of importance of the occlusion regions are calculated based upon ratios of a prescribed object in the occlusion regions of each of the plurality of images. An image containing an occlusion region for which the calculated score is high is decided upon as a representative image. In accordance with the present invention, since an image for which the degree of importance of an image portion in an occlusion region is high (namely an image having a large proportion of the prescribed object) is decided upon as a representative image, an image in which a highly important image portion (the prescribed object) does not appear can be prevented from being decided upon as a representative image.

For example, the score calculation device calculates scores, which represent degrees of importance of the occlusion regions detected by the occlusion region detection device, based upon at least one among ratios of a prescribed object contained in the occlusion regions of respective ones of the plurality of images, strengths of images within the occlusion regions, saturations of images within the occlusion regions, brightnesses of images within the occlusion regions, areas of the occlusion regions and variance of images within the occlusion regions.

For example, the score calculation device performs calculation so as to raise the score of a region where occlusion regions overlap.

In a case where the plurality of images are three or more, the decision device decides upon images of two or more frames, which contain occlusion regions for which the scores calculated by the score calculation device are high, as representative images, by way of example.

The apparatus may further comprise a compression device for performing compression in such a manner that the more an image is one containing an occlusion region for which the score calculated by the score calculation device is high, the smaller the ratio of compression applied.

The apparatus may further comprise a first notification device (first notification means) for giving notification in such a manner that imaging is performed from a viewpoint (on at least one of both sides of the representative image) that is near a viewpoint of the representative image decided by the decision device.

In a case where the plurality of images are three or more, the decision device decides upon images of two or more frames, which contain occlusion regions for which the scores calculated by the score calculation device are high, as representative images, by way of example. In addition, the apparatus further comprises: a determination unit (determination means) for determining whether the images of the two frames decided by the decision unit were captured from adjacent viewpoints; and a second notification unit (second notification means), responsive to a determination made by the determination unit that the images of the two frames decided by the decision unit were captured from adjacent viewpoints, for giving notification in such a manner that imaging will be performed from a viewpoint between viewpoints at two locations at which the two frames of images were captured, and responsive to a determination made by the determination unit that the images of the two frames decided by the decision unit were not captured from adjacent viewpoints, for giving notification in such a manner that imaging will be performed from a viewpoint close to the viewpoint of an image containing an occlusion region having the highest score.

The decision unit decides that an image containing an occlusion region with the highest score is a representative image, by way of example. In this case, the apparatus further comprises a recording control device (recording control means) for correlating, and recording on a recording medium, image data representing each image of the plurality of images and data identifying representative image decided by the decision device.

The prescribed object is, for example, a face.

An image compression apparatus according to a second aspect of the present invention is characterized by comprising: an occlusion region detection device (occlusion region detection means) for detecting, from image of a plurality of images captured from different viewpoints and having at least one portion in common, an occlusion region that does not appear in other images; a score calculation device (score calculation means) for calculating scores, which represent degrees of importance of the occlusion regions detected by the occlusion region detection device, based upon ratios of a prescribed object contained in the occlusion regions of each of the plurality of images; and a compression device (compression means) for performing compression in such a manner that the more an image is one containing an occlusion region for which the score calculated by the score calculation device is high, the smaller the ratio of compression applied.

The second aspect of the present invention also provides an operation control method suited to the above-described image compression apparatus. Specifically, the method comprises: an occlusion region detection device detecting, from each of a plurality of images captured from different viewpoints and having at least one portion in common, an occlusion region that does not appear in other images; a score calculation device calculating scores, which represent degrees of importance of the occlusion regions detected by the occlusion region detection device, based upon ratios of a prescribed object contained in the occlusion regions of each of the plurality of images; and a compression device performing compression in such a manner that the more an image is one containing an occlusion region for which the score calculated by the score calculation device is high, the smaller the ratio of compression applied.

The second aspect of the present invention also provides a program for implementing the method of controlling the operation of the above-described image compression apparatus. Further, it may be arranged so that a recording medium on which such an operation program has been stored is provided as well.

In accordance with the second aspect of the present invention, occlusion regions are detected from respective ones of a plurality of images, the occlusion regions not appearing in other images. Scores representing degrees of importance of the occlusion regions are calculated based upon ratios of a prescribed object in the occlusion regions of respective ones of the plurality of images. Compression (low compression) is performed in such a manner that the more an image is one containing an occlusion region for which the calculated score is high, the smaller the ratio of compression applied. The more an image is one for which the degree of importance of an occlusion region is high, the higher the image quality of the image obtained.

### BRIEF DESCRIPTION OF THE DRAWINGS

FIG. 1a illustrates a left-eye image and FIG. 1b a right-eye image;

FIG. 2 is a flowchart illustrating a processing procedure for deciding a representative image;

FIG. 3a illustrates a left-eye image and FIG. 3b a right-eye image;

FIGS. 4 to 9 are examples of score tables;

FIGS. 10a to 10c illustrate three images having different viewpoints;

FIG. 11 is an example of an image;

FIGS. 12 and 13 are flowcharts illustrating a processing procedure for deciding a representative image;

FIGS. 14a to 14c illustrate three images having different viewpoints;

FIG. 15 is an example of an image;

FIGS. 16a to 16c illustrate three images having different viewpoints;

FIG. 17 is an example of an image;

FIG. 18 is a flowchart illustrating the processing procedure of a shooting assist mode;

FIG. 19 is a flowchart illustrating the processing procedure of a shooting assist mode; and

FIG. 20 is a block diagram illustrating the electrical configuration of a stereoscopic imaging still camera.

### BEST MODE FOR CARRYING OUT THE INVENTION

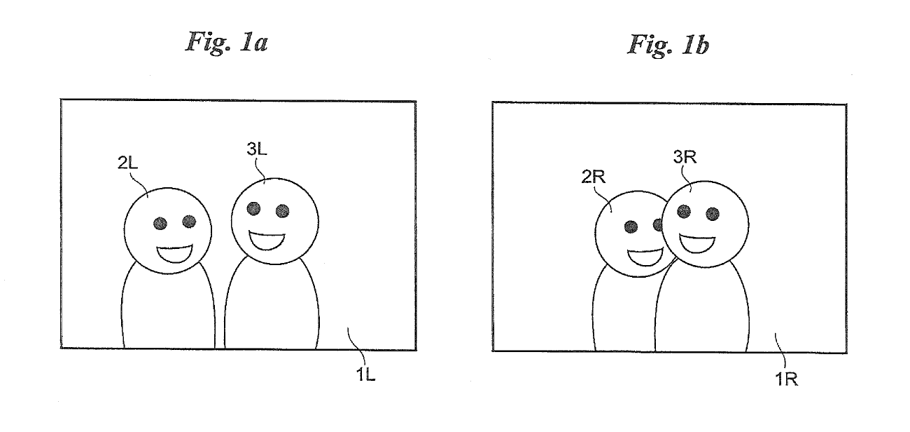

FIGS. 1a and 1b illustrate images captured by a stereoscopic imaging digital still camera. FIG. 1a is an example of a left-eye image (an image for left eye) 1L viewed by the left eye of an observer at playback and FIG. 1b an example of a right-eye image (an image for right eye) 1R viewed by the right eye of the observer at playback. The left-eye image 1L and right-eye image 1R have been captured from different viewpoints and a portion of the imaging zone is common to both images.

The left-eye image 1L contains person images 2L and 3L, and the right-eye image 1R contains person images 2R and 3R. The person image 2L contained in the left-eye image 1L and the person image 2R contained in the right-eye image 1R represent the same person, and the person image 3L contained in the left-eye image 1L and the person image 3R contained in the right-eye image 1R represent the same person.

The left-eye image 1L and the right-eye image 1R have been captured from different viewpoints. How the person image 2L and person image 3L contained in the left-eye image 1L look differs from how the person image 2R and person image 3R contained in the right-eye image 1R look. There is an image portion that appears in the left-eye image 1L but not in the right-eye image 1R. Conversely, there is an image portion that appears in the right-eye image 1R but not in the left-eye image 1L.

This embodiment decides a representative image from a plurality of images which share at least a portion in common from among a plurality of images that have been captured from different viewpoints. In the example shown in FIGS. 1a and 1b, either the left-eye image 1L or the right-eye image 1R is decided upon as the representative image.

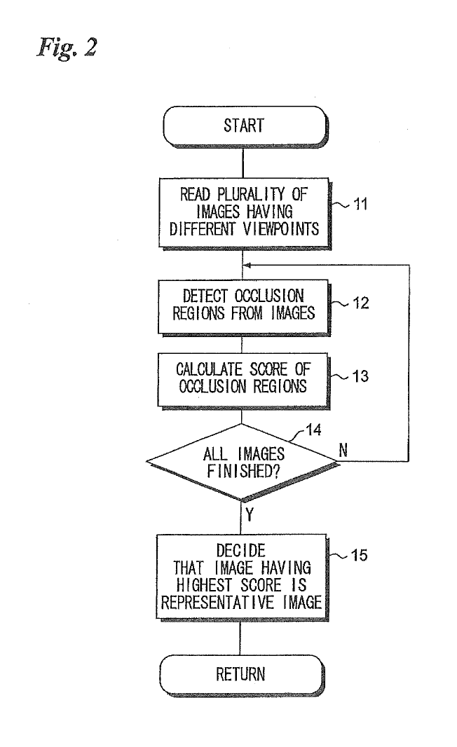

FIG. 2 is a flowchart illustrating a processing procedure for deciding a representative image.

The left-eye image 1L and right-eye image 1R, which are multiple images the viewpoints of which are different, as shown in FIGS. 1a and 1b, are read (step 11). Image data representing the left-eye image 1L and right-eye image 1R has been recorded on a recording medium such as a memory card, and the image data is read from the memory card. Naturally, the image data representing the left-eye image 1L and the right-eye image 1R may just as well be obtained directly from the image capture device and not recorded on a memory card. The image capture device is capable of stereoscopic imaging and may be one in which the left-eye image 1L and right-eye image 1R are obtained at the same time, or the left-eye image 1L and right-eye image 1R may be obtained by performing image capture two times using a single image capture device. Detected from each image read, namely from the left-eye image 1L and the right-eye image 1R, are regions (referred to as “occlusion regions”) that do not appear in the other image (step 12).

First, occlusion regions in the left-eye image 1L are detected (occlusion regions in the right-eye image 1R may just as well be detected). The left-eye image 1L and the right-eye image 1R are compared, and regions represented by pixels for which pixels corresponding to the pixels constituting the left-eye image 1L do not exist in the right-eye image 1R are adopted as the occlusion regions in the left-eye image 1L.

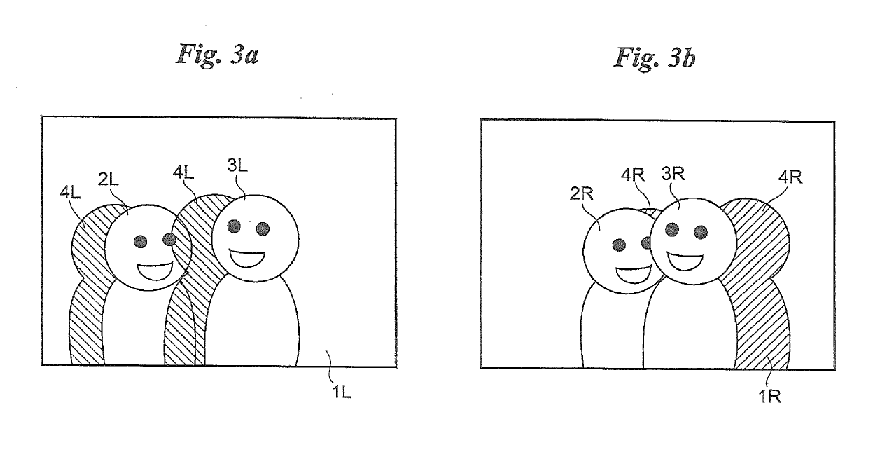

FIGS. 3a and 3b show the left-eye image 1L and the right-eye image 1R, in which occlusion regions are illustrated.

In the left-eye image 1L shown in FIG. 3a, occlusion regions 4L are indicated by hatching on the left side of the person images 2L and 3L. The image portions within these occlusion regions 4L are not contained in the right-eye image 1R.

When the occlusion regions 4L in the left-eye image 1L are detected, the score of the occlusion regions 4L is calculated (step 13). The method of calculating scores will be described later.

If the detection of occlusion regions and the calculation of the scores of occlusion regions has not ended with regard to all images of the plurality of images read (“NO” at step 14), then the detection of occlusion regions and the calculation of the scores of occlusion regions is performed with regard to the remaining images. In this case, occlusion regions regarding the right-eye image are detected (step 12).

FIG. 3b shows the right-eye image 1R, in which occlusion regions are illustrated.

Regions represented by pixels for which pixels corresponding to the pixels constituting the right-eye image 1R do not exist in the left-eye image 1L are adopted as occlusion regions 4R in the right-eye image 1R. In the right-eye image 1R shown in FIG. 3b, occlusion regions 4R are indicated by hatching on the right side of the person images 2R and 3R. The image portions within these occlusion regions 4R are not contained in the left-eye image 1L.

The score of the occlusion regions 4L in the left-eye image 1L and the score of the occlusion regions 4R in the right-eye image 1R are calculated (step 13 in FIG. 2). The method of calculating scores will be described later.

When the detection of occlusion regions and the calculation of the scores of occlusion regions is finished with regard to all of the images read (“YES” at step 14), the image containing the occlusion regions having the highest score is decided upon as a representative image (step 15).

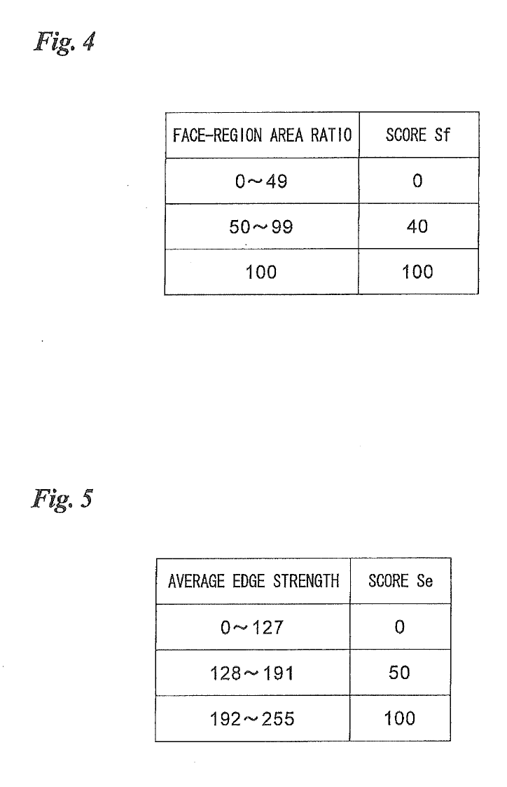

FIGS. 4 to 9 are examples of score tables.

FIG. 4 illustrates values of scores Sf decided in accordance with area ratios of face regions contained in occlusion regions.

If the proportion of a face contained in an occlusion region is 0% to 49%, 50% to 99% or 100%, then the score Sf is 0, 40 or 100, respectively.

FIG. 5 illustrates values of scores Se decided in accordance with average edge strengths of image portions in occlusion regions.

If, in a case where edge strength takes on levels from 0 to 255, the average edge strength of the image portion of an occlusion region takes on a level from 0 to 127, a level from 128 to 191 or a level from 192 to 255, then the score Se is 0, 50 or 100, respectively.

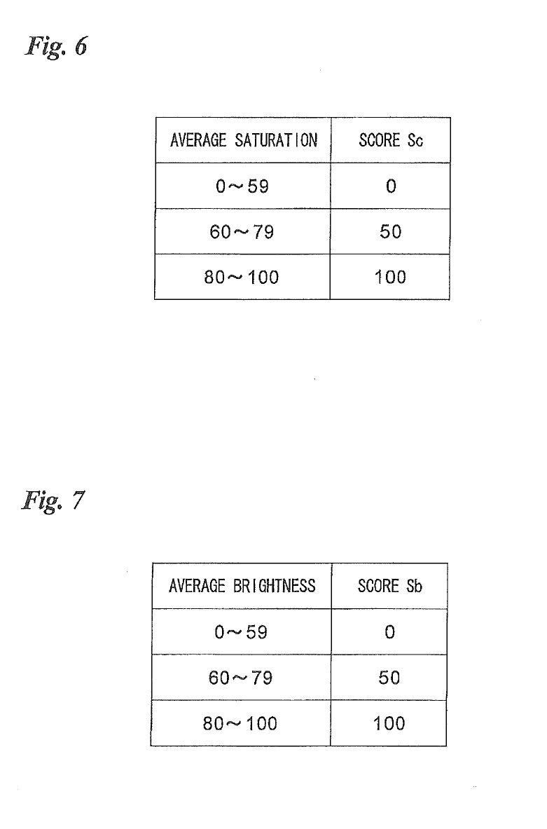

FIG. 6 illustrates values of scores Sc decided in accordance with average saturations of image portions in occlusion regions.

If, in a case where average saturation takes on levels from 0 to 100, the average saturation of the image portion of an occlusion region takes on a level from 0 to 59, a level from 60 to 79 or a level from 80 to 100, then the score is 0, 50 or 100, respectively.

FIG. 7 illustrates values of scores Sb decided in accordance with average brightnesses of image portions in occlusion regions.

If, in a case where average brightness takes on levels from 0 to 100, the average brightness of the image portion of an occlusion region takes on a level from 0 to 59, a level from 60 to 79 or a level from 80 to 100, then the score is 0, 50 or 100, respectively.

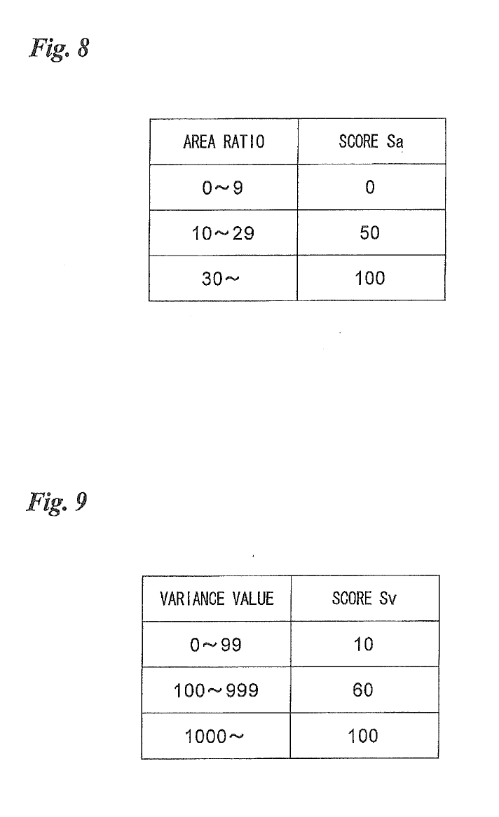

FIG. 8 illustrates values of scores Sa decided in accordance with area ratios of occlusion regions relative to the entire image.

If the area ratio is 0% to 9%, 10% to 29% or 30% or greater, then the score Sa is 0, 50 or 100, respectively.

FIG. 9 illustrates values of scores Sv decided in accordance with variance values of pixels within occlusion regions.

In a case where a variance takes on a value of 0 to 99, a value of 100 to 999 or a value of 1000 or greater, the score Sv is 10, 60 or 100.

A total score St is thus calculated from Equation 1 from the score Sf in accordance with face-region area ratio, the score Se in accordance with average edge strength, the score Sc in accordance with average saturation, the score Sb in accordance with average brightness, the score Sa in accordance with occlusion-region area ratio, and the score Sv in accordance with variance value. In Equation 1, α1 to α6 are arbitrary coefficients.

St=α1×Sf+α2×Se+α3×Sc+α4×Sb+α5×Sa+α6×Sv Equation 1

The image containing the occlusion region for which the score St thus calculated is highest is decided upon as the representative image.

In the embodiment described above, a representative image is decided using the total score St. However, the image adopted as the representative image may just as well be the image that contains the occlusion region for which any one score is highest from among the score Sf in accordance with face-region area ratio, score Se in accordance with average edge strength, score Sc in accordance with average saturation, score Sb in accordance with average brightness, score Sa in accordance with occlusion-region area ratio and score Sv in accordance with variance value, or the occlusion region for which the sum of any combination of these scores is highest. For example, the representative image may be decided from the score Sf obtained based solely upon area ratios of face regions contained in occlusion regions (here the face is an object, but the object may be other than a face). Further, the representative image may just as well be decided from the score Sf of the face-region area ratio and at least one from among the score Se in accordance with average edge strength, score Sc in accordance with average saturation, score Sb in accordance with average brightness, score Sa in accordance with occlusion-region area ratio and score Sv in accordance with variance value.

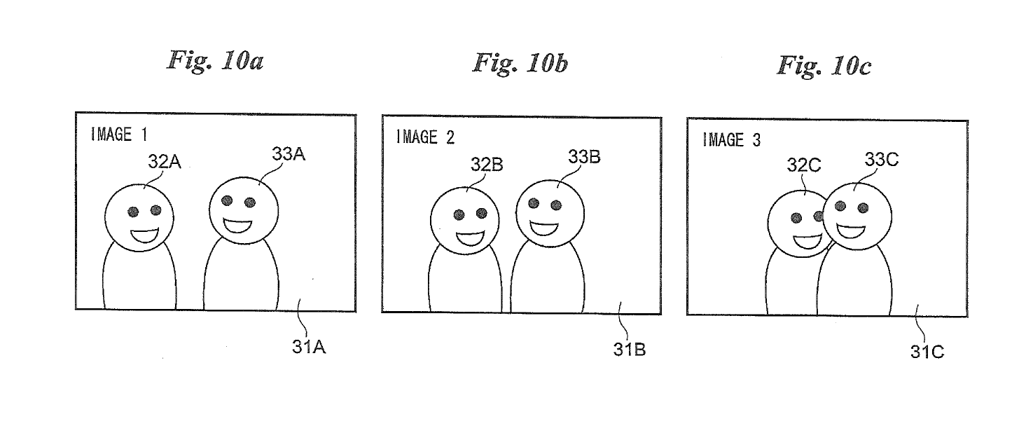

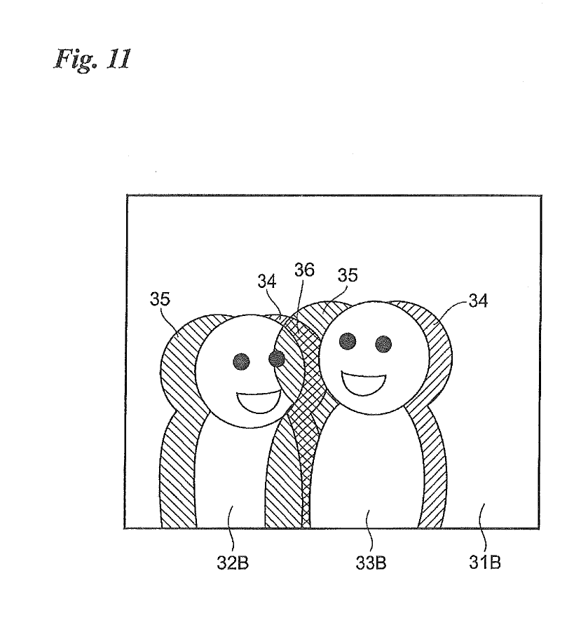

FIGS. 10a, 10b and 10c and FIG. 11 illustrate a modification.

This modification decides a representative image from the images of three frames. Operation is similar also for images of four frame or more.

FIGS. 10a, 10b and 10c are examples of a first image 31A, a second image 31B and a third image 31C captured from different viewpoints and having at least a portion of the imaging zone in common. The second image 31B is an image obtained in a case where the image was captured from the front side of the subject. The first image 31A is an image obtained in a case where the image was captured from a viewpoint leftward of the second image 31B (to the left of the subject). The third image 31C is an image obtained in a case where the image was captured from a viewpoint rightward of the second image 31B (to the right of the subject).

The first image 31A contains a person image 32A and a person image 33A, the second image 31B contains a person image 32B and a person image 33B, and the third image 31C contains a person image 32C and a person image 33C. The person images 32A, 32B and 32C represent the same person, and the person images 33A, 33B and 33C represent the same person.

FIG. 11 shows the second image 31B, in which occlusion regions are illustrated.

The occlusion regions of the second image 31B include first occlusion regions that appear in the second image 31B but not in the first image 31A, second occlusion regions that appear in the second image 31B but not in the third image 31C, and a third occlusion region that appears in the second image 31B but neither in the first image 31A nor in the third image 31C.

Occlusion regions 34 on the right side of the person image 32B and on the right side of the person image 33B are first occlusion regions 34 that appear in the second image 31B but not in the first image 31A. Occlusion regions 35 on the left side of the person image 32B and on the left side of the person image 33B are second occlusion regions 35 that appear in the second image 31B but not in the third image 31C. A region in which the first occlusion region 34 on the right side of the person image 32B and the second occlusion region 35 on the left side of the person image 33B overlap is a third occlusion region 36 that appears in the second image 31B but neither in the first image 31A nor in the third image 31C. Thus, in the case of images of three or more frames, there exist an occlusion region (the third occlusion region 36) which indicates an image portion that does not appear in any images other than the image for which the score of the occlusion regions is calculated, as well as occlusion regions (the first occlusion regions 34 and second occlusion regions 35) which indicate image portions that do not appear only in some of the other images. When scores are calculated, the weighting of a score obtained from an occlusion region which indicates an image portion that does not appear in any images other than the image for which the score of the occlusion regions is calculated is increased, and the weighting of a score obtained from an occlusion region which indicates an image portion that does not appear only in some of the other images is increased (the score of the occlusion region 36 of overlap is raised). Naturally, such weighting need not be changed.

If a representative image is decided as set forth above, the representative image decided is displayed on a display device that displays two-dimensional images. Further, it may be arranged so that, in a case where image data representing images having a plurality of different viewpoints is stored in a single image file, image data representing a thumbnail image of the decided representative image is recorded in the header of the file. Naturally, it may be arranged so that identification data of the representative image is recorded in the header of the file.

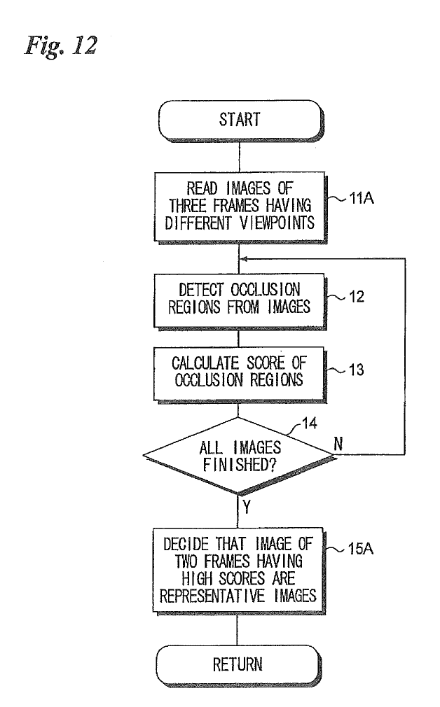

FIG. 12 is a flowchart illustrating a processing procedure for deciding a representative image. FIG. 12 corresponds to FIG. 2, and processing steps in FIG. 12 identical with those shown in FIG. 2 are designated by like step numbers and need not be described again.

In this embodiment, images of three frames are read (the number of frames may be more than three) (step 11A). The scores of occlusion regions are calculated in each of the images of the three frames (steps 12 to 14). From among the images of the three frames, the images of two frames having high scores are decided upon as representative images (step 15A). Thus, representative images may be of two frames and not one frame. By deciding upon the images of two frames as representative images, a stereoscopic image can be displayed using the images of the two frames that have been decided. In a case where images of four or more frames have been read, the representative images may be of three or more frames, as a matter of course.

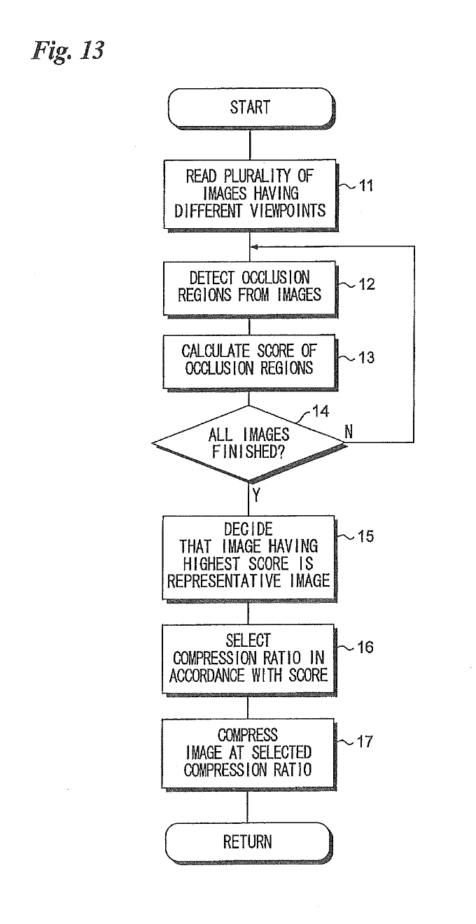

FIG. 13 is a flowchart illustrating a processing procedure for deciding a representative image and for image compression. FIG. 13 corresponds to FIG. 2, and processing steps in FIG. 13 identical with those shown in FIG. 2 are designated by like step numbers and need not be described again.

The representative image is decided in the manner described above (step 15). The scores of occlusion regions have been stored with regard to respective ones of all read images. A compression ratio is selected. Specifically, the higher the score of an occlusion region, the lower the compression ratio, which will result in less compression, selected (step 16). Compression ratios are predetermined and a selection is made from among these determined compression ratios. Each image of the read images is compressed using the selected compression ratio (step 17). The higher the score of an occlusion region, the more important the image is deemed to be, and the more important an image, the higher the image quality thereof becomes.

In the foregoing embodiment, a compression ratio is selected (decided) upon deciding that an image having the highest calculated score is a representative image, and the image is compressed at the compression ratio selected. However, the compression ratio may be selected without deciding that an image having the high score is a representative image. That is, an arrangement may be adopted in which occlusion regions are detected from each image of a plurality of images, a compression ratio is selected in accordance with the scores of the detected occlusion regions, and each image is compressed at the compression ratio selected.

In the above-described embodiment as well, a representative image may be decided using the total score St, as mentioned above, and a compression ratio may be selected in accordance with any one score from among score Sf in accordance with face-region area ratio, score Se in accordance with average edge strength, score Sc in accordance with average saturation, score Sb in accordance with average brightness, score Sa in accordance with occlusion-region area ratio and score Sv in accordance with variance value, or in accordance with the sum of any combination of these scores. For example, the representative image may be decided from the score Sf obtained based solely upon area ratios of face regions contained in occlusion regions (here the face is an object, but the object may be other than a face). Further, the compression ratio may be selected from the score Sf of the face-region area ratio and at least one from among the score Se in accordance with average edge strength, score Sc in accordance with average saturation, score Sb in accordance with average brightness, score Sa in accordance with occlusion-region area ratio and score Sv in accordance with variance value.

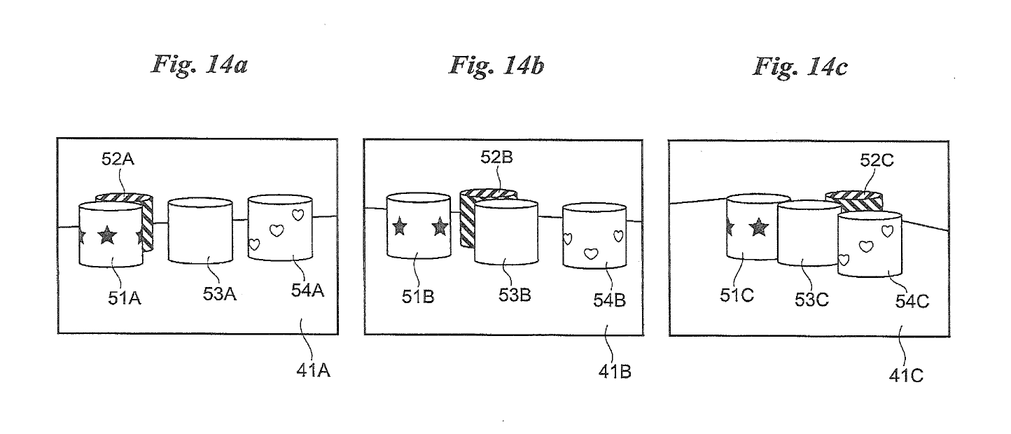

FIGS. 14 to 18 illustrate another embodiment. This embodiment utilizes images of three or more frames, which have already been captured, to decide a viewpoint that will be suitable when the image of the next frame is captured. This embodiment images the same subject from different viewpoints.

FIGS. 14a, 14b and 14c show a first image 41A, a second image 41B and a third image 41C captured from different viewpoints.

The first image 41A contains subject images 51A, 52A, 53A and 54A, the second image 41B contains subject images 51B, 52B, 53B and 54B, and the third image 41C contains subject images 51C, 52C, 53C and 54C. The subject images 51A, 51B and 51C represent the same subject, the subject images 52A, 52B and 52C represent the same subject, the subject images 53A, 53B and 53C represent the same subject, and the subject images 54A, 54B and 54C represent the same subject. It is assumed that the first image 41A, second image 41B and third image 41C have been captured from adjacent viewpoints.

In the manner described above, occlusion regions are detected from each of first image 41A, second image 41B and third image 41C (the occlusion regions are not shown in FIGS. 14a, 14b and 14c), and the scores of the occlusion regions are calculated. For example, assume that the score of the first image 41A shown in FIG. 14a is 60, the score of the second image 41B shown in FIG. 14b is 50 and the score of the third image 41C shown in FIG. 14c is 10.

In this embodiment, if two images having the higher-order scores are adjacent, then an image captured from a viewpoint between the two viewpoints from which these two images were captured is considered to be an important image. Accordingly, the user is notified so as to shoot from the viewpoint between the two viewpoints from which the two images having the higher-order scores were captured. In the example shown in FIGS. 14a, 14b and 14c, since the first image 41A and second image 41B are the two images having the higher-order scores, the user is notified so as to shoot from the viewpoint between the viewpoint used when the first image 41A was captured and the viewpoint used when the second image 41B was captured. For example, the first image 41A and the second image 41B would be displayed on a display screen provided on the back side of the digital still camera, and a message “SHOOT FROM IN BETWEEN DISPLAYED IMAGES” would be displayed in the form of characters or output in the form of voice.

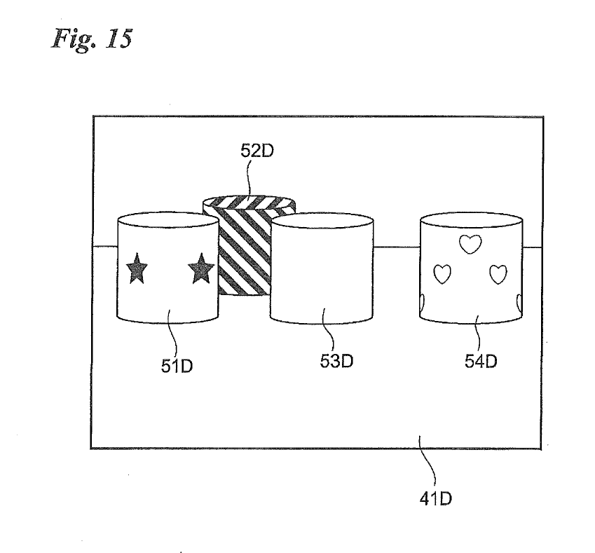

FIG. 15 shows an image 41D obtained by shooting from a viewpoint that is between the viewpoint used when the first image 41A was captured and the viewpoint used when the second image 41B was captured.

The image 41D contains subject images 51D, 52D, 53D and 54D. The subject image 51D represents the same subject as that of the subject image 51A of first image 41A, the subject image 51B of second image 41B and the subject image 51C of third image 41C shown in FIGS. 14a, 14b and 14c. Similarly, the subject image 52D represents the same subject as that of the subject images 52A, 52B and 52C, the subject image 53D represents the same subject as that of the subject images 53A, 53B and 53C, and the subject image 54D represents the same subject as that of the subject images 54A, 54B and 54C.

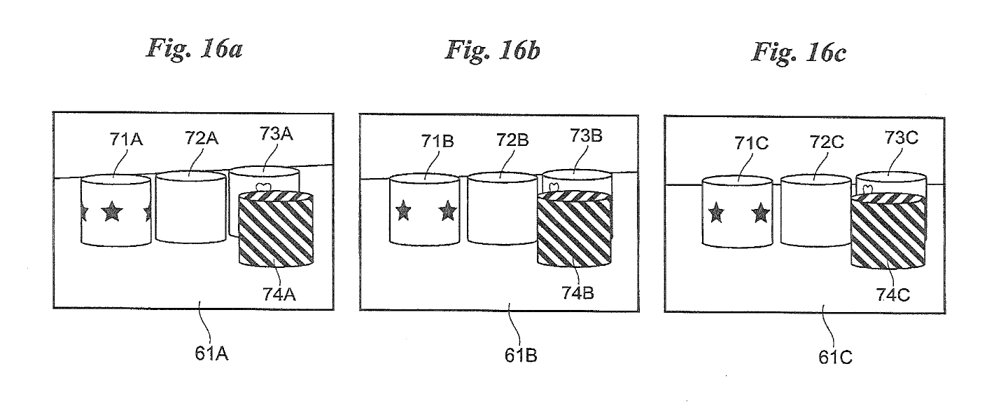

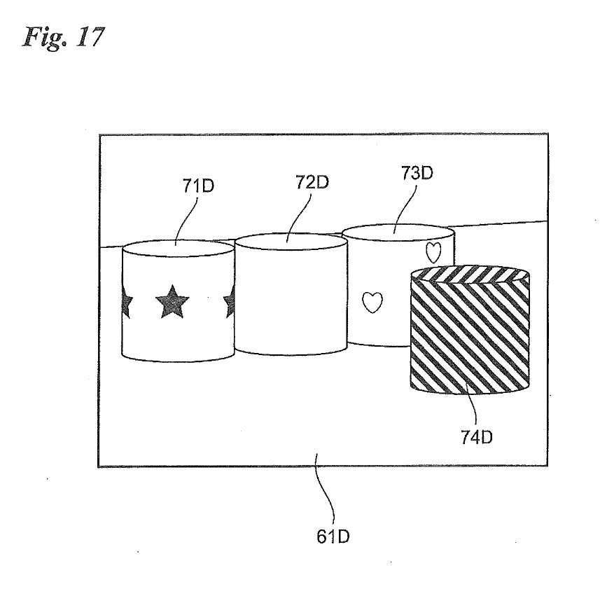

FIGS. 16a, 16b and 16c show a first image 61A, a second image 61B and a third image 61C captured from different viewpoints.

The first image 61A contains subject images 71A, 72A, 73A and 74A, the second image 61B contains subject images 71B, 72B, 73B and 74B, and the third image 61C contains subject images 71C, 72C, 73C and 74C. The subject images 71A, 71B and 71C represent the same subject, the subject images 72A, 72B and 72C represent the same subject, the subject images 73A, 73B and 73C represent the same subject, and the subject images 74A, 74B and 74C represent the same subject. It is assumed that the first image 61A, second image 61B and third image 61C also have been captured from adjacent viewpoints.

Occlusion regions are detected from each of first image 61A, second image 61B and third image 61C (the occlusion regions are not shown in FIGS. 16a, 16b and 16c), and the scores of the occlusion regions are calculated. For example, assume that the score of the first image 61A shown in FIG. 16a is 50, the score of the second image 61B shown in FIG. 16b is 30 and the score of the third image 61C shown in FIG. 16c is 40.

If two images having the higher-order scores are adjacent, then an image captured from a viewpoint between the two viewpoints from which these two images were captured is considered to be an important image, as mentioned above. However, in a case where two images having the higher-order scores are not adjacent, the image having the highest score is considered important and the user is notified so as to shoot from a viewpoint that is in the vicinity of the viewpoint from which this image was captured. In the example shown in FIGS. 16a, 16b and 16c, the two images having the higher-order scores are the first image 61A and the third image 61C. Since these images 61A and 61C are not images that were captured from adjacent viewpoints, the user is notified so as to shoot from the vicinity of the viewpoint of image 61A having the highest score. (For example, the user is notified so as to shoot from a viewpoint that is on the left side of the viewpoint from which the first image 61A was captured.) For instance, the first image 61A would be displayed on a display screen provided on the back side of the digital still camera, and text would be displayed indicating that shooting from a viewpoint on the left side of the viewpoint of the image 61A is desirable.

FIG. 17 shows an image 61D obtained by shooting from a viewpoint that is on the left side of the viewpoint used when the first image 61A was captured.

The image 61D contains subject images 71D, 72D, 73D and 74D. The subject image 71D represents the same subject as that of the subject image 71A of first image 61A, the subject image 71B of second image 61B and the subject image 71C of third image 61C shown in FIGS. 16a, 16b and 16c. Similarly, the subject image 72D represents the same subject as that of the subject images 72A, 72B and 72C, the subject image 73D represents the same subject as that of the subject images 73A, 73B and 73C, and the subject image 74D represents the same subject as that of the subject images 74A, 74B and 74C.

The user can be made to capture the image thought to be important.

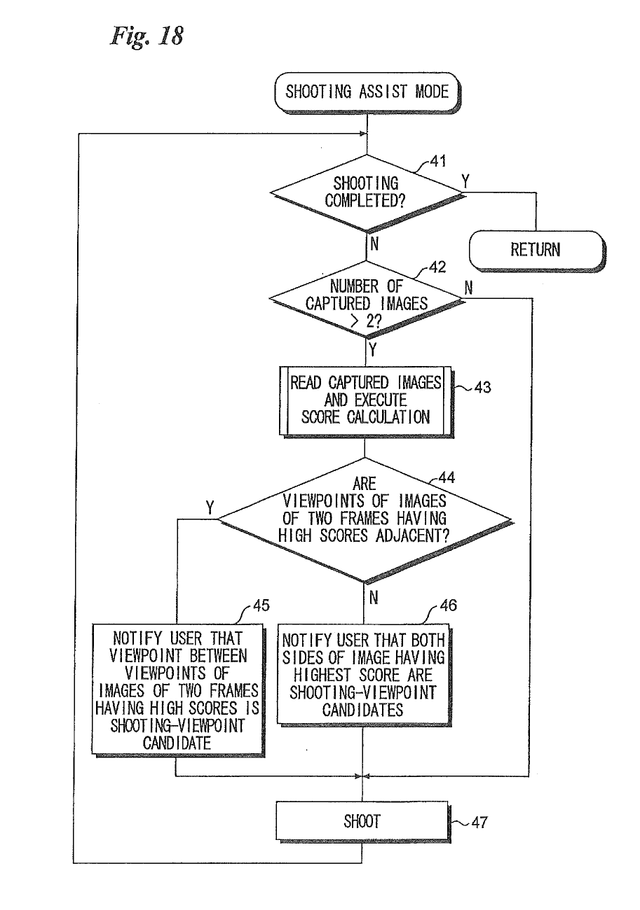

FIG. 18 is a flowchart illustrating a processing procedure for shooting in the above-described shooting assist mode. This processing procedure is for shooting using a digital still camera.

This processing procedure is started by setting the shooting assist mode. If the shooting mode per se has not ended owing to end of imaging or the like (“NO” at step 41), then whether captured images obtained by imaging the same subject are more than two frames in number is ascertained (step 42). If the captured images are not more than two frames in number (“NO” at step 42), then a shooting viewpoint cannot be decided using images of three or more frames in the manner set forth above. Accordingly, imaging is performed from a different viewpoint decided by the user.

If the captured images are more than two frames in number (“YES” at step 42), then image data representing the captured images is read from the memory card and score calculation processing is executed for every image in the manner described above (step 43).

In a case where the viewpoints of two frames of images having the higher-order scores for the occlusion regions are adjacent (“YES” at step 44), as illustrated in FIGS. 14a, 14b and 14c, the user is notified of the fact that a viewpoint between the viewpoints of the two frames of images having the higher-order scores for the occlusion regions is a candidate for a shooting viewpoint (step 45). In a case where the viewpoints of two frames of images having the higher-order scores for the occlusion regions are not adjacent (“NO” at step 44), as illustrated in FIGS. 16a, 16b and 16c, the user is notified of the fact that both sides (the vicinity thereof) of the image containing the occlusion region for which the score is highest are candidates for shooting viewpoints (step 46). Of both viewpoints of the image containing the occlusion region for which the score is highest, notification is given that only the viewpoint from which the image has not been captured is the candidate for a shooting viewpoint. As to whether images are images having adjacent viewpoints or not, if shooting-location position information has been appended to each of a plurality of having different viewpoints, then the determination can be made from this position information. Further, if the direction in which viewpoints change has been decided in such a manner that a plurality of images having different viewpoints are captured in a certain direction in terms of order of capture and, moreover, the order in which the image data representing these plurality of images is stored in image files or on a memory card is decided in advance, then the storage order and the direction in which the viewpoints change will correspond. Accordingly, whether images are images having adjacent viewpoints or not can be ascertained. Furthermore, by comparing corresponding points, which are points where pixels constituting the images correspond, between the images, the positional relationship between the subject and the camera that captured the image can be ascertained from the result of this comparison, and whether viewpoints are adjacent of not can be ascertained.

When the user ascertains the candidate for the shooting viewpoint, the users shoots the subject upon referring to this candidate (step 47). An image thought to be important is thus obtained. Highly precise shooting assist becomes possible.

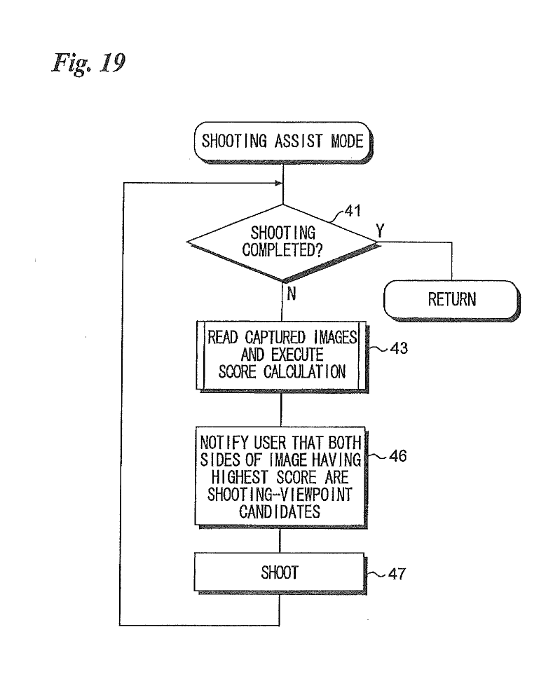

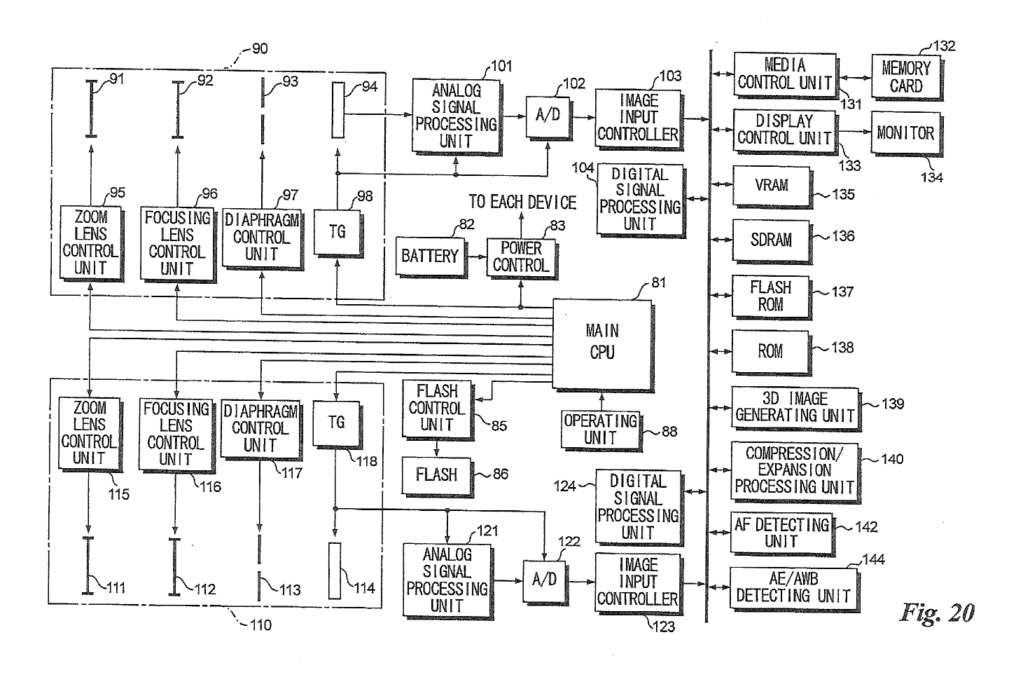

FIG. 19 is a flowchart illustrating a processing procedure for shooting in the above-described shooting assist mode. This processing procedure is for shooting using a digital still camera. The processing procedure shown in FIG. 19 corresponds to that shown in FIG. 18, and processing steps in FIG. 19 identical with those shown in FIG. 18 are designated by like step numbers and need not be described again.

In the embodiment shown in FIG. 18, the user is notified of the fact that a point between the viewpoints of two frames of images of higher scores is a candidate for a shooting viewpoint in a case where the viewpoints of the two frames of images of higher scores are adjacent, and the user is notified of the fact that both sides of the image having the highest score are candidates for shooting viewpoints in a case where the viewpoints of the two frames of images of higher scores are not adjacent. In this embodiment, on the other hand, the user is notified of the fact that both sides (or at least one side) of the image having the highest score are candidates for shooting viewpoints irrespective of whether the viewpoints of the two frames of images of higher scores are adjacent (step 46).

When the user ascertains the candidate for a shooting viewpoint, the user shoots the subject upon referring to the candidate (step 47). An image thought to be important is thus obtained in this embodiment as well. Highly precise shooting assist becomes possible.

FIG. 20 shows the electrical configuration of a stereoscopic imaging digital camera for implementing the above-described embodiment.

The program for controlling the above-described operation has been stored in a memory card 132, the program is read by a media control unit 131 and is installed in a stereoscopic imaging digital camera. Naturally, the operation program may be pre-installed in the stereoscopic imaging still camera or may be applied to the stereoscopic imaging digital camera via a network.

The overall operation of the stereoscopic imaging digital camera is controlled by a main CPU 81. The stereoscopic imaging digital camera is provided with an operating unit 88 that includes various buttons such as a mode setting button for setting a shooting assist mode, a stereoscopic imaging mode, a two-dimensional imaging mode, a stereoscopic playback mode and a two-dimensional playback mode, etc., and a shutter-release button of two-stage stroke type. An operation signal that is output from the operating unit 88 is input to the main CPU 81.

The stereoscopic imaging digital camera includes a left-eye image capture device 90 and a right-eye image capture device 110. When the stereoscopic imaging mode is set, a subject is imaged continuously (periodically) by the left-eye image capture device 90 and right-eye image capture device 110. When the shooting assist mode or the two-dimensional imaging mode is set, a subject is imaged only by the left-eye image capture device 90 (or the right-eye image capture device 110).

The left-eye image capture device 90 images the subject, thereby outputting image data representing a left-eye image that constitutes a stereoscopic image. The left-eye image capture device 90 includes a first CCD 94. A first zoom lens 91, a first focusing lens 92 and a diaphragm 93 are provided in front of the first CCD 94. The first zoom lens 91, first focusing lens 92 and diaphragm 93 are driven by a zoom lens control unit 95, a focusing lens control unit 96 and a diaphragm control unit 97, respectively. When the stereoscopic imaging mode is set and the left-eye image is formed on the photoreceptor surface of the first CCD 94, a left-eye video signal representing the left-eye image is output from the first CCD 94 based upon clock pulses supplied from a timing generator 98.

The left-eye video signal that has been output from the first CCD 94 is subjected to prescribed analog signal processing in an analog signal processing unit 101 and is converted to digital left-eye image data in an analog/digital converting unit 102. The left-eye image data is input to a digital signal processing unit 104 from an image input controller 103. The left-eye image data is subjected to prescribed digital signal processing in the digital signal processing unit 104. Left-eye image data that has been output from the digital signal processing unit 104 is input to a 3D image generating unit 139.

The right-eye image capture device 110 includes a second CCD 114. A second zoom lens 111, second focusing lens 112 and a diaphragm 113 driven by a zoom lens control unit 115, a focusing lens control unit 116 and a diaphragm control unit 117, respectively, are provided in front of the second CCD 114. When the imaging mode is set and the right-eye image is formed on the photoreceptor surface of the second CCD 114, a right-eye video signal representing the right-eye image is output from the second CCD 114 based upon clock pulses supplied from a timing generator 118.

The right-eye video signal that has been output from the second CCD 114 is subjected to prescribed analog signal processing in an analog signal processing unit 121 and is converted to digital right-eye image data in an analog/digital converting unit 122. The right-eye image data is input to the digital signal processing unit 124 from an image input controller 123. The right-eye image data is subjected to prescribed digital signal processing in the digital signal processing unit 124. Right-eye image data that has been output from the digital signal processing unit 124 is input to the 3D image generating unit 139.

Image data representing the stereoscopic image is generated in the 3D image generating unit 139 from the left-eye image and right-eye image and is input to a display control unit 133. A monitor display unit 134 is controlled by the display control unit 133, whereby the stereoscopic image is displayed on the display screen of the monitor display unit 134.

When the shutter-release button is pressed through the first stage of its stroke, the items of left-eye image data and right-eye image data are input to an AF detecting unit 142 as well. Focus-control amounts of the first focusing lens 92 and second focusing lens 112 are calculated in the AF detecting unit 142. The first focusing lens 92 and second focusing lens 112 are positioned at in-focus positions in accordance with the calculated focus-control amounts.

The left-eye image data is input to an AE/AWB detecting unit 144. Respective amounts of exposure of the left-eye image capture device 90 and right-eye image capture device 110 are calculated in the AE/AWB detecting unit 144 using the data representing the face detected from the left-eye image (which may just as well be the right-eye image). The f-stop value of the first diaphragm 93, the electronic-shutter time of the first CCD 94, the f-stop value of the second diaphragm 113 and the electronic-shutter time of the second CCD 114 are decided in such a manner that the calculated amounts of exposure will be obtained. An amount of white balance adjustment is also calculated in the AE/AWB detecting unit 144 from the data representing the face detected from the entered left-eye image (or right-eye image). Based upon the calculated amount of white balance adjustment, the left-eye video signal is subjected to a white balance adjustment in the analog signal processing unit 101 and the right-eye video signal is subjected to a white balance adjustment in the analog signal processing unit 121.

When the shutter-release button is pressed through the second stage of its stroke, the image data (left-eye image and right-eye image) representing the stereoscopic image generated in the 3D image generating unit 139 is input to a compression/expansion unit 140. The image data representing the stereoscopic image is compressed in the compression/expansion unit 140. The compressed image data is recorded on the memory card 132 by the media control unit 131. In a case where the compression ratio is selected, as described above, in accordance with the degrees of importance of the left-eye image and right-eye image, the items of left-eye image and right-eye image are stored in an SDRAM 136 temporarily and which of the left- and right-eye images is important is determined as set forth above.

Compression is carried out in the compression/expansion unit 140 upon raising the compression ratio (raising the percentage of compression) of whichever of the left- and right-eye images is determined to be important. The compressed image data is recorded on the memory card 132.

The stereoscopic imaging camera further includes a VRAM 135 for storing various types of data, the SDRAM 136 in which the above-described score tables have been stored, a flash ROM 137 and a ROM 138 for storing various data. The stereoscopic imaging digital camera further includes a battery 83. Power supplied from the battery 83 is applied to a power control unit 83. The power control unit 83 supplies power to each device constituting the stereoscopic imaging digital camera. The stereoscopic imaging digital camera further includes a flash unit 86 controlled by a flash control unit 85.

When the stereoscopic image playback mode is set, the left-eye image data and right-eye image data recorded on the memory card 132 is read and input to the compression/expansion unit 140. The left-eye image data and right-eye image data is expanded in the compression/expansion unit 140. The expanded left-eye image data and right-eye image data is applied to the display control unit 133, whereupon a stereoscopic image is displayed on the display screen of the monitor display unit 134.

If, in a case where the stereoscopic image playback mode has been set, images captured from three or more different viewpoints exist with regard to the same subject, two images from among these three or more images are decided upon as representative images in the manner described above. A stereoscopic image is displayed by applying the two decided images to the monitor display unit 134.

When the two-dimensional image playback mode is set, the left-eye image data and right-eye image data (which may just as well be image data representing three of more images captured from different viewpoints) that has been recorded on the memory card 132 is read and is expanded in the compression/expansion unit 140 in a manner similar to that of the stereoscopic image playback mode. Either the left-eye image represented by the expanded left-eye image data or the right-eye image represented by the expanded right-eye image data is decided upon as the representative image in the manner described above. The image data representing the image decided is applied to the monitor display unit 134 by the display control unit 133.

If, in a case where the shooting assist mode has been set, three or more images captured from different viewpoints with regard to the same subject have been stored on the memory card 132, as mentioned above, shooting-viewpoint assist information (an image or message, etc.) is displayed on the display screen of the monitor display unit 134. The subject is shot from the shooting viewpoint using the left-eye image capture device 90 of the left-eye image capture device 90 and right-eye image capture device 110 (or use may be made of the right-eye image capture device 110).

In the above-described embodiment, a stereoscopic imaging digital camera is used. However, a digital camera for two-dimensional imaging may be used rather than a stereoscopic imaging digital camera.

In a case where a representative image is decided, as described above, left-eye image data, right-eye image data and data identifying a representative image (e.g., a frame number or the like) are correlated and recorded on the memory card 132. For example, in a case where left-eye image data and right-eye image data is stored in the same file, data indicating which of the left-eye image or right-eye image is the representative image would be stored in the header of the file.

Furthermore, in the above-described embodiment, the description is rendered with regard to two images, namely a left-eye image and a right-eye image. However, it goes without saying that a decision regarding a representative image and selection of compression ratio can be carried out in similar fashion with regard to three or more images and not just two images.

1. A representative image decision apparatus comprising:
an occlusion region detection device for detecting, from each image of a plurality of images captured from different viewpoints and having at least one portion in common, an occlusion region that does not appear in the other images;
a score calculation device for calculating scores, which represent degrees of importance of the occlusion regions detected by said occlusion region detection device, based upon ratios of a prescribed object contained in the occlusion regions of each of the plurality of images; and
a decision device for deciding that an image containing an occlusion region for which the score calculated by said score calculation device is high is a representative image.

2. A representative image decision apparatus according to claim 1, wherein said score calculation device calculates scores, which represent degrees of importance of the occlusion regions detected by said occlusion region detection device, based upon at least one among ratios of a prescribed object contained in the occlusion regions of each of the plurality of images, strengths of images within the occlusion regions, saturations of images within the occlusion regions, brightnesses of images within the occlusion regions, areas of the occlusion regions and variance of images within the occlusion regions.

3. A representative image decision apparatus according to claim 2, wherein said score calculation device performs calculation so as to raise the score of a region where occlusion regions overlap.

4. A representative image decision apparatus according to claim 3, wherein said plurality of images are three or more; and
said decision device decides upon images of two or more frames, which contain occlusion regions for which the scores calculated by said score calculation device are high, as representative images.

5. A representative image decision apparatus according to claim 4, further comprising a compression device for performing compression in such a manner that the more an image is one containing an occlusion region for which the score calculated by said score calculation device is high, the smaller the ratio of compression applied.

6. A representative image decision apparatus according to claim 5, further comprising a first notification device giving notification in such a manner that imaging is performed from a viewpoint that is near a viewpoint of a representative image decided by said decision device.

7. A representative image decision apparatus according to claim 6, wherein said plurality of images are three or more;
said decision device decides upon images of two or more frames, which contain occlusion regions for which the scores calculated by said score calculation device are high, as representative images; and
said apparatus further comprises:
a determination unit for determining whether the images of the two frames decided by said decision unit were captured from adjacent viewpoints; and
a second notification unit, responsive to a determination made by said determination unit that the images of the two frames decided by said decision unit were captured from adjacent viewpoints, for giving notification in such a manner that imaging will be performed from a viewpoint between viewpoints at two locations from which the two frames of images were captured, and responsive to a determination made by said determination unit that the images of the two frames decided by said decision unit were not captured from adjacent viewpoints, for giving notification in such a manner that imaging will be performed from a viewpoint close to the viewpoint of an image containing an occlusion region having the highest score.

8. A representative image decision apparatus according to claim 7, wherein said decision device decides that an image containing an occlusion region having the highest score calculated by said score calculation device is a representative image; and
said apparatus further comprises a recording control device for correlating, and recording on a recording medium, image data representing each image of said plurality of images and data identifying a representative image decided by said decision device.

9. A representative image decision apparatus according to claim 8, wherein said prescribed object is a face.

10. An image compression apparatus comprising:
an occlusion region detection device for detecting, from each image of a plurality of images captured from different viewpoints and having at least one portion in common, an occlusion region that does not appear in the other images;
a score calculation device for calculating scores, which represent degrees of importance of the occlusion regions detected by said occlusion region detection device, based upon ratios of a prescribed object contained in the occlusion regions of each of the plurality of images; and
a compression device for performing compression in such a manner that the more an image is one containing an occlusion region for which the score calculated by said score calculation device is high, the smaller the ratio of compression applied.

11. A method of controlling operation of a representative image decision apparatus, comprising:
an occlusion region detection device detecting, from each of a plurality of images captured from different viewpoints and having at least one portion in common, an occlusion region that does not appear in the other images;
a score calculation device calculating scores, which represent degrees of importance of the occlusion regions detected by said occlusion region detection device, based upon ratios of a prescribed object contained in the occlusion regions of each of the plurality of images; and
a decision device deciding that an image containing an occlusion region for which the score calculated by said score calculation device is high is a representative image.

12. A method of controlling operation of a representative image decision apparatus, comprising:
an occlusion region detection device detecting, from each of a plurality of images captured from different viewpoints and having at least one portion in common, an occlusion region that does not appear in the other images;
a score calculation device calculating scores, which represent degrees of importance of the occlusion regions detected by said occlusion region detection device, based upon ratios of a prescribed object contained in the occlusion regions of each of the plurality of images; and
a compression device performing compression in such a manner that the more an image is one containing an occlusion region for which the score calculated by said score calculation device is high, the smaller the ratio of compression applied.

13. A computer-readable program for controlling a computer of a representative image decision apparatus so as to:
detect, from each of a plurality of images captured from different viewpoints and having at least one portion in common, an occlusion region that does not appear in the other images;
calculate scores, which represent degrees of importance of the occlusion regions detected, based upon ratios of a prescribed object contained in the occlusion regions of each of the plurality of images; and
decide that an image containing an occlusion region for which the calculated score is high is a representative image.

14. A computer-readable program for controlling a computer of a representative image decision apparatus so as to:
detect, from each of a plurality of images captured from different viewpoints and having at least one portion in common, an occlusion region that does not appear in the other images;
calculate scores, which represent degrees of importance of the occlusion regions detected, based upon ratios of a prescribed object contained in the occlusion regions of each of the plurality of images; and
perform compression in such a manner that the more an image is one containing an occlusion region for which the calculated score is high, the smaller the ratio of compression applied.
